(19) United States
(12) Patent Application Publication
(10) Pub. No.: US 2025/0070548 A1
(43) Pub. Date: Feb. 27, 2025

(54) DISTRIBUTION SYSTEM PROTECTION DEVICE WITH VARIABLE CURRENT SETTINGS

(71) Applicant: Hubbell Incorporated, Shelton, CT (US)

(72) Inventors: David Adelbert Rhein, Birmingham, AL (US); Chandiran Sundarraj, Tamilnadu (IN)

(21) Appl. No.: 18/813,655

(22) Filed: Aug. 23, 2024

Related U.S. Application Data
(60) Provisional application No. 63/578,286, filed on Aug. 23, 2023.

(51) Int. Cl. H02H 7/22

(52) U.S. Cl. CPC H02H 7/22

(57) ABSTRACT

A recloser for a distribution system includes a current sensor configured to measure an operating current of a distribution system. A controller is connected to the current sensor. The controller has at least one processor. A circuit interrupter is connected to the controller and configured to open a circuit to interrupt power in at least a portion of the distribution system. A selector is in communication with the controller. The selector is operable by a user to select one of a plurality of fuse curves. The controller is configured to trigger the circuit interrupter to open the circuit in response to a detected fault current. The fault current is determined based on a selected fuse curve of one of the plurality of fuse curves.

### RELATED APPLICATION(S)

This application is based on U.S. Provisional Application Ser. No. 63/578,286, filed Aug. 23, 2023, the disclosure of which is incorporated herein by reference in its entirety and to which priority is claimed.

### FIELD

Various implementations relate to fuse devices for power distribution systems.

### BACKGROUND

Circuit interrupting devices, such as circuit breakers, sectionalizers, cutouts, and reclosers provide protection for power distribution systems and the various apparatus on those power distribution systems such as transformers and capacitor banks by isolating a faulted section from the main part of the system. A fault current in the system can occur under various conditions, including but not limited to lighting, an animal or tree shorting the power lines, or different power lines contacting each other. Conventional circuit interrupting devices sense a fault and interrupt the current path. Conventional reclosers also re-close the current path and monitor continued fault conditions, thereby re-energizing the utility line upon termination of the fault. This provides maximum continuity of electrical service. If a fault is permanent, the recloser remains open after a certain number of reclosing operations that can be pre-set.

A fuse cutout is a combination of a fuse and a switch that is actuated by an overcurrent event. An overcurrent caused by a fault in the transformer or customer circuit will cause the fuse to melt, disconnecting the transformer from the line. To facilitate disconnection, cutouts are typically mounted about 20 degrees off vertical so that the center of gravity of the fuse holder is displaced and the fuse holder will rotate and fall open under its own weight when the fuse blows. Mechanical tension on the fuse link normally holds an ejector spring in a stable position. When the fuse blows, the released spring pulls the stub of the fuse link out of the fuse holder tube to reduce surge duration and damage to the transformer and fuse holder to quench any are in the fuse holder. The cutout can also be opened manually by utility linemen standing on the ground and using a long insulating stick called a “hot stick”.

A cutout can include three major components. The first component is the cutout insulator body, a generally open C-shaped frame that includes a conductive top hood piece and a conductive bottom hinge pieces which cooperate to accept a fuse holder as well as a ribbed porcelain or polymer insulator main portion that electrically isolates the conductive portions from the support bracket to which the insulator is fastened via a centrally extending mounting flange.

The second component is the fuse holder itself, also called the “fuse tube”, that is an insulating tube which contains the replaceable fuse element. When the fuse element operates (“melts”), the fuse holder subsequently drops out of the upper contact of the top hood of the insulator body, breaking the circuit, and hangs from a hinge on its lower end that cooperates with the bottom hinge of the insulator body via a pinion. The hanging fuse holder provides a visible indication that the fuse has operated and assurance that the circuit is open. The circuit can also be opened manually by pulling out the fuse holder using a hot stick with approved load break device.

The third component is the fuse element, or “fuse link”, which is the replaceable portion of the cutout assembly that operates when the electrical current is great enough. In operation, after the fuse link has blown and the fuse holder drops, a lineman replaces the fuse link and re-deploys the fuse tube in its operating condition between the conductive top hood and bottom hinge pieces of the fuse cutout insulator body. The fuse holder can be equipped with a pull ring that can be engaged by a hook at the end of the fiberglass hot stick operated by a lineworker standing on the ground or from a bucket truck, to manually close/open the switch.

If equipped with appropriate mechanisms, cutouts can act as sectionalizers, used on each distribution line downstream from autoreclosing circuit breakers. Autoreclosers sense and briefly interrupt fault currents, and then automatically reclose to restore service. Meanwhile, downstream sectionalizers automatically count current interruptions by the recloser. When a sectionalizer detects a preset number of interruptions of fault current (typically 2, 3, or 4) the sectionalizer opens (while unenergized) and remains open, and the recloser restores supply to the other non-fault sections.

Fuse cutouts can also be utilized as a dropout recloser. A dropout recloser can determine the number of fault current interruptions and drop from a cutout once the set number of faults is reached. A dropout recloser can therefore include reclosing components and fault interrupting components. These components can include the dropout mechanism of a standard fuse cutout, along with a controller housed, for example, with the fuse tube, and configured to determine an overcurrent condition, count the overcurrent cycles over a given time, and activate the dropout mechanism as needed.

### SUMMARY

In certain configurations, a fuse device for a distribution system includes a variable current setting.

In certain configurations, a fuse device for a distribution system includes a variable current setting configurable via a user interface on the fuse device.

In certain configurations, a fuse device for a distribution system includes a variable current setting configurable via a user interface including one or more dial selectors.

In certain configurations, a fuse device for a distribution system includes a variable current setting configurable via a user interface including one or more magnets.

In certain configurations, a fuse device for a distribution system includes a variable current setting allowing a user to adjust a fuse curve type.

In certain configurations, a fuse device for a distribution system includes a variable current setting allowing a user to adjust a fuse curve amperage rating.

In certain configurations, a fuse device for a distribution system includes a selector is in communication with a controller. The selector is operable by a user to select one of a plurality of fuse curves. The controller is configured to trigger a circuit interrupter to open the circuit in response to a detected fault current. The fault current is determined based on a selected fuse curve of one of the plurality of fuse curves. The user can modify the fuse curve type, the fuse curve amperage, or both.

In certain configurations, a recloser for a distribution system includes a current sensor configured to measure an operating current of a distribution system. A controller is connected to the current sensor. The controller has at least one processor. A circuit interrupter is connected to the controller and configured to open a circuit to interrupt power in at least a portion of the distribution system. A selector is in communication with the controller. The selector is operable by a user to select one of a plurality of fuse curves. The controller is configured to trigger the circuit interrupter to open the circuit in response to a detected fault current. The fault current is determined based on a selected fuse curve of one of the plurality of fuse curves.

In certain configurations, a distribution system fuse device includes an insulator body having a weathershed. A support bracket extends from the insulator body. A hood is connected to the insulator body, the hood having a hood contact. A hinge member extends from the insulator body. A recloser is pivotally connected to the insulator body by engagement of a pivot with the hinge member. The recloser has a current sensor configured to measure an operating current of a distribution system. A controller is connected to the current sensor, the controller having at least one processor. A circuit interrupter is connected to the controller and configured to open a circuit to interrupt power in at least a portion of the distribution system. A selector is in communication with the controller, the selector operable by a user to select one of a plurality of fuse curveS. The controller is configured to trigger the circuit interrupter to open the circuit in response to a detected fault current. The fault current is determined based on a selected fuse curve of one of the plurality of fuse curves.

In certain implementations, a method of setting the operating parameters of a controller for a distribution system fuse device includes emitting a signal from a first RFID device. The emitted signal is received at a second RFID device. A response is emitted from the second RFID device. The response contains fuse curve data. The fuse curve data is extracted. The operating parameters of a controller are adjusted based on the fuse curve data.

In certain implementations, a method of setting the operating parameters of a controller for a distribution system fuse device includes adjusting the position of a selector. The change in position of the selector is sensed. A signal is emitted to a controller based on the change in position of the selector. The signal is received and fuse curve data is extracted based on the signal. The operating parameters of a controller are adjusted based on the fuse curve data.

### BRIEF DESCRIPTION OF THE DRAWINGS

The aspects and features of various exemplary embodiments will be more apparent from the description of those exemplary embodiments taken with reference to the accompanying drawings.

FIG. 1 is a side perspective view of a dropout recloser.

FIG. 2 is a partial view of the hinge and pivot of the dropout recloser of FIG. 1.

FIG. 3 is a schematic view of the recloser internal components.

FIG. 4 is a chart showing a set of type K fuse curves.

FIG. 5 is a chart showing a set of type T fuse curves.

FIG. 6 is a chart showing a set of type MS fuse curves.

FIG. 7 is a chart showing a set of type STH fuse curves.

FIG. 8 is a chart showing a set of type QH fuse curves.

FIG. 9 is a chart showing a set of type SLOFAST fuse curves.

FIG. 10 is a front view of a fuse curve selector dial.

FIG. 11 is a rear perspective view of a fuse curve selector dial with the rear housing member removed.

FIG. 12 is a rear perspective view of a fuse curve selector dial.

FIG. 13 is a schematic view of the recloser internal components using and RFID system.

FIG. 14 is flow chart of a method of adjusting the operating parameters of the controller based on a received RFID signal.

FIG. 15 is a partial perspective view of a recloser having dual dial selectors.

FIG. 16 is a schematic view of the recloser internal components using a non-wireless connection between the fuse curve selector and the controller.

FIG. 17 is a front perspective view of a fuse selector.

FIG. 18 is a front perspective view of the inner selector, first outer selector, and second outer selector of FIG. 17.

FIG. 19 is rear perspective view of the inner selector, first outer selector, and the second outer selector positioned in a front housing portion of FIG. 17.

FIG. 20 is a rear perspective view of the fuse selector of FIG. 17.

FIG. 21 is a side view of the fuse selector of FIG. 17 and a sensor board.

FIG. 22 is a partially exploded, front perspective view of the fuse selector and sensor board of FIG. 21.

FIG. 23 is a front perspective view of another fuse selector.

FIG. 24 is a front perspective view of the inner selector of FIG. 23.

FIG. 25 is a rear perspective view of the inner selector of FIG. 23.

FIG. 26 is an exploded, front perspective view of the first outer selector and second outer selector of FIG. 23.

FIG. 27 is a rear perspective view of the first outer selector and second outer selector of FIG. 23.

FIG. 28 is a sectional top view of the fuse selector of FIG. 23.

FIG. 29 is another sectional top view of the fuse selector of FIG. 23.

FIG. 30 is a rear perspective view of the fuse selector of FIG. 23.

### DETAILED DESCRIPTION OF EXEMPLARY EMBODIMENTS

Certain implementations are directed to a fuse device used in a power distribution system. The fuse device can be connected to an overhead power line system, for example being connected to a utility pole, either directly or through one or more mounting brackets. The fuse device can be configured to disconnect from the power distribution system when a certain condition occurs, for example one or more overcurrent fault conditions. The fuse device can be reconnected to the power distribution system by a lineman or other technician.

In certain operations, the lineman will engage the fuse device with a hot stick. Hot sticks typically include a pole made from an insulated material such as fiberglass. Hot sticks can have different lengths, ranging from about 6 feet to about 40 feet, and can be telescopic to provide for an adjustable length. This allows lineman to stay a sufficient distance from potentially live voltage components. The end of a hot stick can be equipped with different components on the far end to perform different operations. For example, moveable or stationary hooks can be provided on the far end of the hot stick to allow a lineman to manipulate components at a distance.

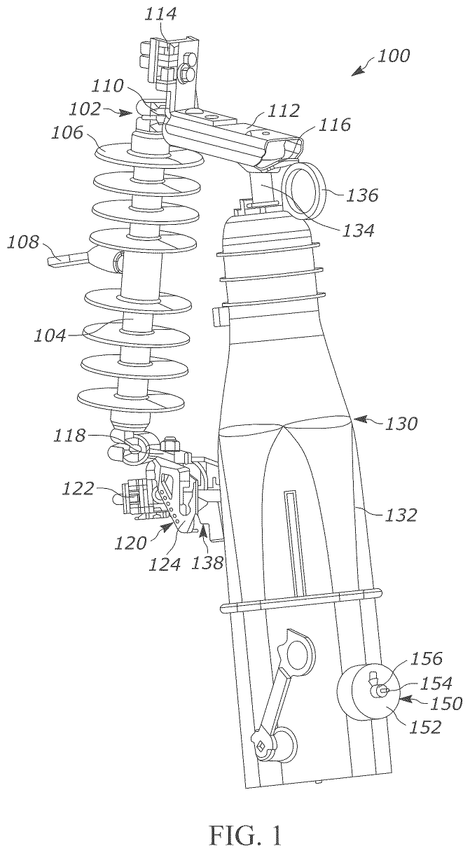

FIG. 1 shows an exemplary circuit interrupting device 100 having a cutout insulator 102. As depicted, the cutout insulator 102 includes an insulator body 104 having a plurality of watersheds 106. The insulator body 104 can be made from a suitable dielectric material. For example, the insulator can include thermal plastic, such as high-density polyethylene (HDPE) or PPE resin. Certain configurations can include thermal set material, such as epoxy or vinyl ester. The insulator body 104 can be molded, for example, injection molded, and the molding can include reinforcing fillers to enhance properties of the insulator body 104, such as, but not limited to, hydrophobic properties, UV stability, and track resistance.

A support bracket 108 extends from the insulator body 104. The support bracket 108 can be connected to a central region of the insulator body 104 and can include an opening to receive a mounting fastener. The support bracket 108 can connect the insulator body 104 to a support, such as a utility pole or crossarm, either directly or connected through one or more mounting brackets. The support bracket 108 or other mounting structure can be configured to mount the insulator body 104 at an angle so that a longitudinal axis of the insulator 102 extends at an oblique angle relative to a vertical axis as determined relative to the ground.

An upper bracket 110 extends from an upper portion of the insulator body 104. The upper bracket 110 can be connected to a hood 112 having a proximal portion and a distal portion. The proximate portion can include an upper terminal 114 that is configured to receive a supply connection. The distal portion can include a hood contact 116 extending from the hood 112. The hood contact 116 can be biased away from the hood 112 by, for example, a spring.

A lower bracket 118 extends from a lower portion of the insulator body 104. The lower bracket 118 connects to a hinge member 120. The hinge member 120 has a lower terminal 122 that receives a load connection. The hinge member 120 also has a pivot connection. The pivot connection can include a pair of arms 124 having an outer hook defining a cradle. The support bracket 108, upper bracket no, and lower bracket 118 can be electrically isolated form one another by the insulator body 104.

A recloser 130 is connected to the cutout insulator 102. The recloser 130 includes a recloser body 132. A recloser contact 134 extends from a first portion of the recloser body 132. The recloser contact 134 is configured to releasably engage the hood contact 116. The recloser contact 134 can be configured to extend into engagement with the hood contact 116 so that the hood contact 116 is biased against the spring. This engagement can provide a retaining force to hold the hood contact 116 and the recloser contact 134 in engagement.

An upper engagement interface can also extend from the first portion of the recloser body 132. The upper engagement interface provides a contact point for a user to manipulate the recloser 130. In certain configurations, the upper engagement interface is configured to interact with a hot stick. In certain configurations, the upper engagement interface can include a ring 136 that extends outwardly from the recloser body 132.

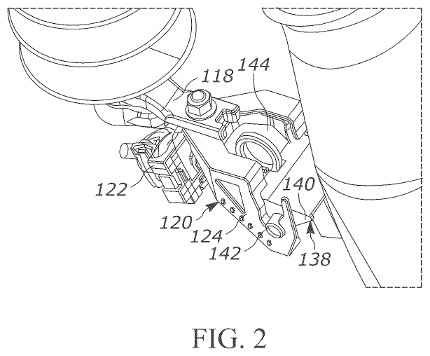

As best shown in FIG. 2, a pivot 138 extends from a second portion of the recloser body 132 spaced from the first portion along a vertical axis. The pivot 138 is positioned and configured to be received in the hinge member 120 of the insulator body 102. The pivot 138 can include a trunnion member 140 which is received in the cradle of the insulator body 102 hinge. The trunnion member 140 can include a pair of opposing projections 142 seated in the cradle to provide a rotatable connection between the recloser 130 and the cutout insulator 102.

A pivot engagement interface can extend from the pivot 138. The pivot engagement interface provides a contact point for a user to manipulate the recloser 130. In certain configurations, the pivot engagement interface is configured to interact with a hot stick. In an exemplary embodiment, the pivot engagement interface can include a second ring 144 that extends outwardly from the pivot 138. The second ring 144 can positioned at a different orientation from the first ring 136. The second ring 144 can be positioned on a different side of the recloser body 132 from the first ring 136. For example, the second ring 144 can be positioned on an opposite side of the recloser body 132 from the first ring 136. In configurations using a cylindrical body, the second ring 144 can be positioned at a different degree along the circumference of the cylindrical body. When other shapes are used, the second ring 144 can be positioned at a different angle relative to a longitudinal axis of the recloser body 132.

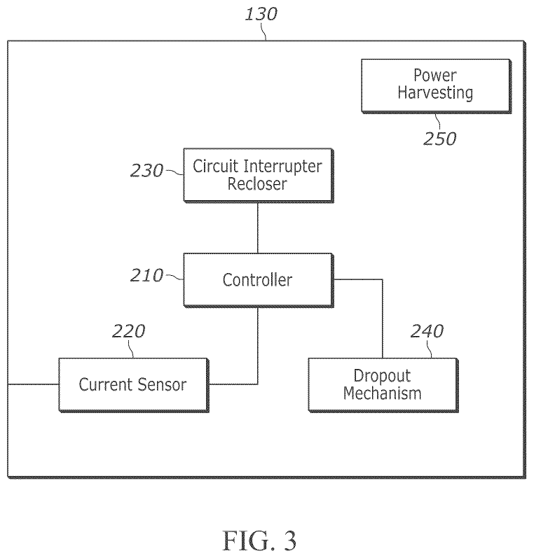

The recloser 130 can contain various internal components depending on the recloser's 130 operational requirements. FIG. 3 shows an exemplary schematic of a recloser 130 and an exemplary configuration of the internal components. These components will vary depending on if the circuit interrupting device 100 is being used as a cutout, sectionailzer, or a dropout recloser. In an example of a configuration as a dropout recloser, the recloser 130 can include a controller 210, a current sensor 220, a circuit interrupter/recloser 230, and a dropout mechanism 240. The circuit interrupter/recloser 230 can be a vacuum interrupter, although other types of interrupters may also be used. The circuit interrupter/recloser 230 can be activated by the controller to open when a fault is detected and to reclose after a certain amount of time. If the fault is not cleared after a certain amount of attempts, a dropout mechanism 240 can be activated to cause the recloser 130 to rotate in the hinge, separating the recloser contact 134 and the hood contact 116. The dropout mechanism 240 can include an actuator, for example a solenoid, that causes movement of the recloser 130 relative to the insulator 102.

The controller 210 can be configured to control the necessary functions and components of the recloser 130. The controller 210 can include one or more PCBs, microprocessors, microcontrollers, volatile and/or non-volatile memory, circuitry components (capacitors, transistors, etc.), and firmware that can be adjusted or updated by a user as necessary. One or more power harvesting components 250 can be included to provide power to various components. The power harvesting components 250 can include one or more power conversion devices (e.g., for converting AC power to DC power) and one or more power storage devices such as one or more capacitors or batteries. Any type of direct and indirect electrical connection can be used to supply power from the power harvesting components 250 to the other internal components. The types, number, and architecture of these components can be varied depending on the requirements of the recloser 130 as would be understood by one of ordinary skill in the art.

During an exemplary operation, the recloser 130 will initially be set so that the pivot 138 is seated in the hinge member 120 and the recloser contact 134 is engaged with the hood contact 116. If a fault condition is detected, the interrupter/recloser 230 can open for a set amount of time and then closed to see if the fault is cleared. If the fault is not cleared after a certain number of openings (e.g., two, three, or four), the dropout mechanism 240 is activated and the recloser 130 is pivoted so the recloser contact 134 is out of engagement with the hood contact 116, opening that portion of the distribution system. The recloser 130 pivots about the hinge member 120 so that the recloser body 132 is hanging in a downward orientation. A user, such as a lineman or other technician, will then need to go and reset the device by manually pivoting the recloser 130 back into engagement with the hood 112. The recloser 130 can also be removed from the hinge member 120 before being reset to or adjust components as needed.

In different applications, the controller and certain associated circuitry (e.g. solenoid, capacitors, etc.) will need to determine a fault condition based on different operating parameters of the system. In certain configurations, the controller and the associated circuitry will act as a fuse, operating on a fuse curve to determine the presence of a fault (e.g., excess current) and triggering an open/close cycle or dropout condition. For example, the current sensor 220 can provide data to the controller 210 on the operating current of the device, and the controller 210 can be configured to determine if a fault current is present and activate the circuit interrupter 230 as needed. In determining if the fault current is present, the controller 210 can compare the current over a period of time.

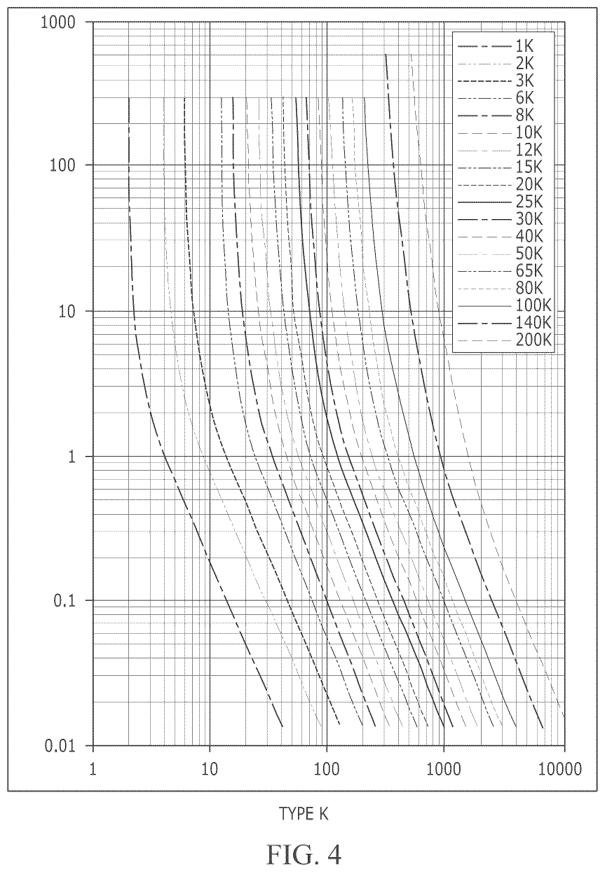

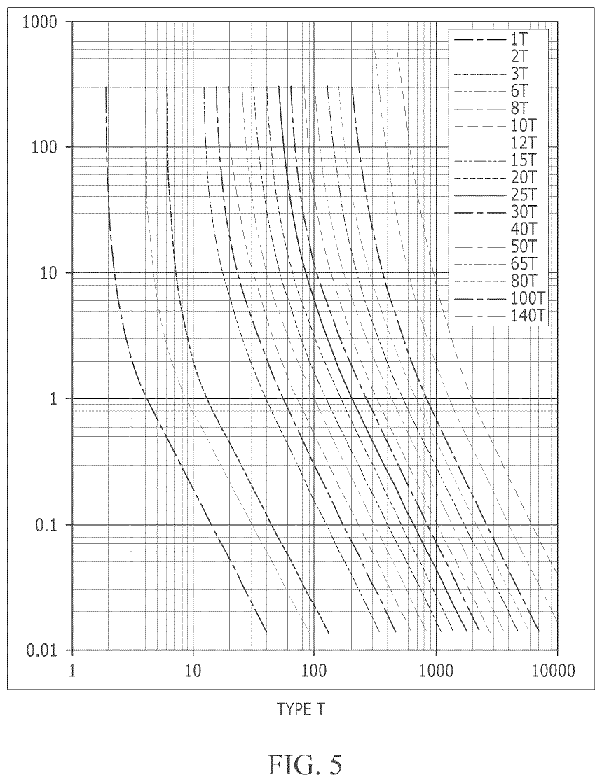

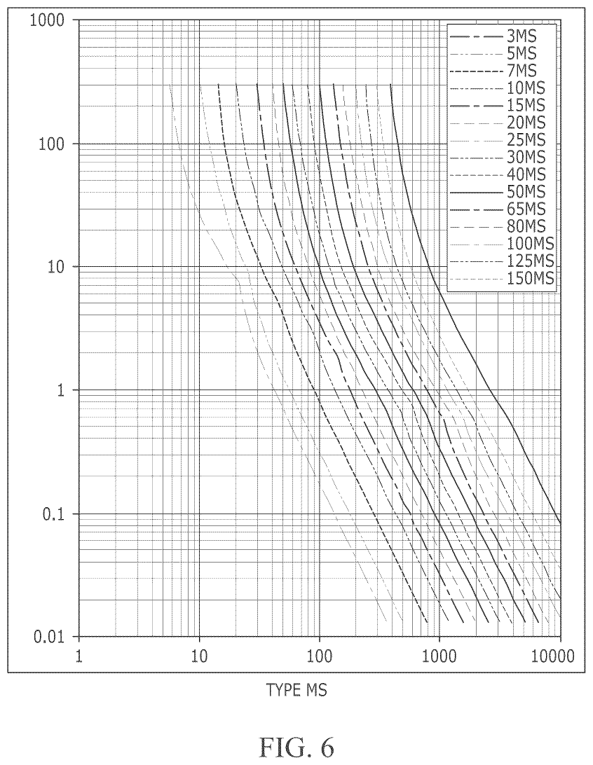

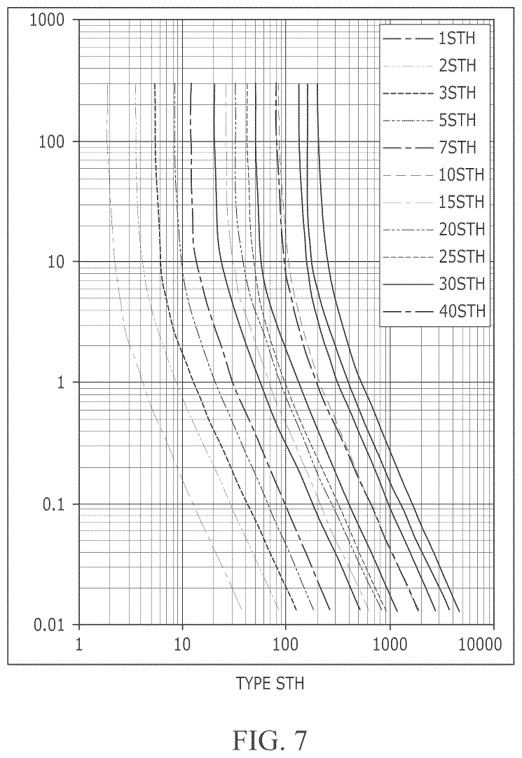

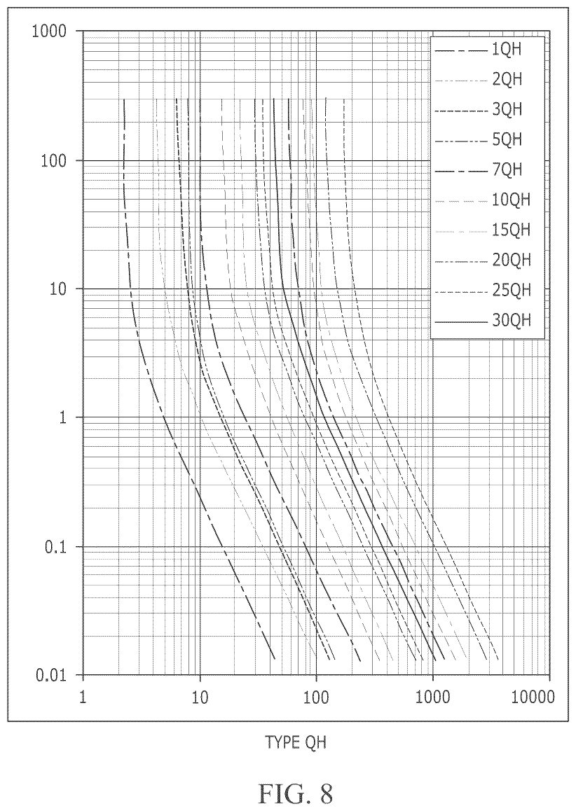

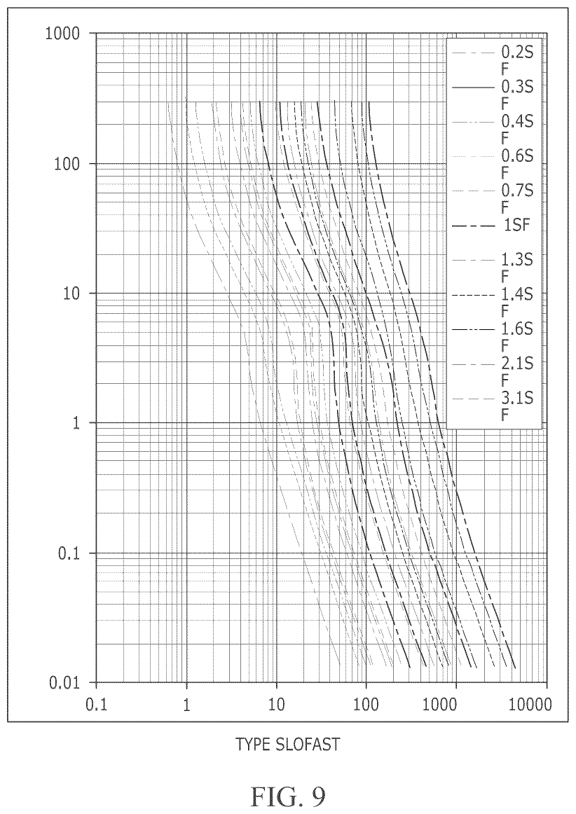

FIGS. 4-9 show exemplary fuse curve tables that can be simulated by the controller 210. Each chart shows a different type of curve (K, T, MS, STH, QH, SLOFAST) and each curve in the charts shows a different fuse amp rating for the type. The fuse curves show the time on the Y axis versus the current on the X axis. If a certain current over a set time as shown in the curves is reach than a fault condition can be triggered. These fuse curves (or the underlying data) can be saved in memory and the controller 210 can be configured to access and follow one or more of these curves as needed.

Typically, the fuse curve pattern for a device is set before the device is placed in the field. This can lead to many complications because protection products like a fuses or reclosers must have variable current protection trip or melt settings to be able to fit in a multitude of distribution circuit configuration and load levels. Also, coordination with other circuit protection devices already on the distribution circuit require multiple trip (melt) times or fuse curves. Factory preset has limitation in that utilities must inventory a multitude of SKUs for maintenance and replacement. Microcontroller based designs reduce the number of SKUs but require energy sources at the time of installation like batteries and communications devices with applications like phones or computers to complete the setting selection process.

In various exemplary embodiments, the recloser 130 can include a user interface (e.g., a selector device) that allows the user to set the fuse curve on the recloser body 132 and modify the fuse curve as needed. FIGS. 1 and 10-12 show an exemplary configuration of a fuse selector dial 150 extending from the recloser body 132. The fuse selector dial 150 includes a dial housing 152, an inner knob 154, and an outer knob 156. The inner knob 154 and the outer knob 156 can be used to select the different fuse curve type and the different amp rating.

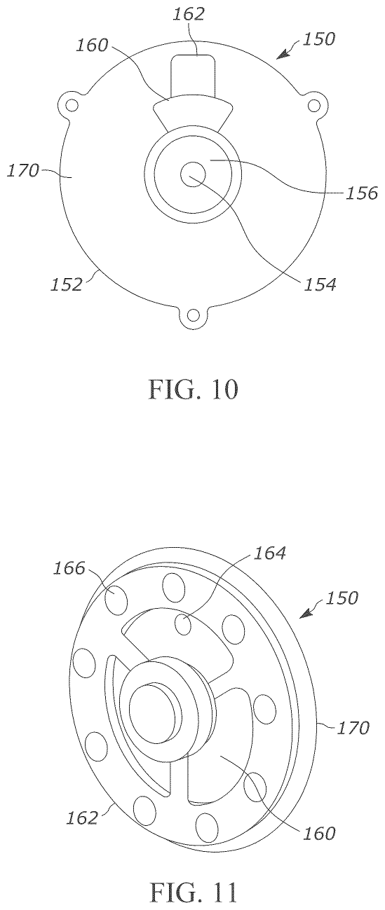

As best shown in FIGS. 10-12, the fuse selector dial 150 can include an inner ring 160 and an outer ring 162. The position of the inner ring 160 can be controlled by the inner knob 154 and the position of the outer ring 162 can be controlled by the outer knob 156. The front surface of the inner and outer rings 160, 162 can include an indicator that shows the type of fuse curve and amp rating being selected. For example, in the illustrated embodiment the inner ring 160 shows a K fuse type selected and the outer ring 162 shows a 2 amp rating selected. The controller 210 will then follow the 2 amp K curve pattern when this is selected.

In other examples (not shown), the selector device may include an interface other than (or in addition to) a dial or knob. For example, the selector device may include one or more buttons and/or one or more switches. Different positions of the button and/or the switch may correspond to different fuse curve type and/or different amp rating. The button and/or switch may be manipulated to a desired position to select a fuse curve and/or amp rating. In other examples, the recloser 130 may include a screen (e.g., an LCD screen). The screen may display selectable fuse curves and/or amp ratings. In certain forms, at least one of a dial, button, switch, or other similar selector may be used to make a selection on the screen. In other forms, the screen may be a touch screen.

In certain configurations, the selector dial 150 signals the controller using a Radio Frequency Identification (RFID) system that includes a first set of RFID tags 164 positioned on the inner dial 160 and a second set of RFID tags 166 positioned on the outer dial 162. In certain configurations, each tag 164, 166 comprises an RFID integrated circuit (IC) and an antenna. The RFID IC includes a memory unit capable of storing unique identification data and may also feature additional memory for storing auxiliary information. The tags' antenna facilitates communication with a reader device by transmitting and receiving RF signals. The tags 164, 166 can be configured as read-only tags, having information permanently programmed into the tag.

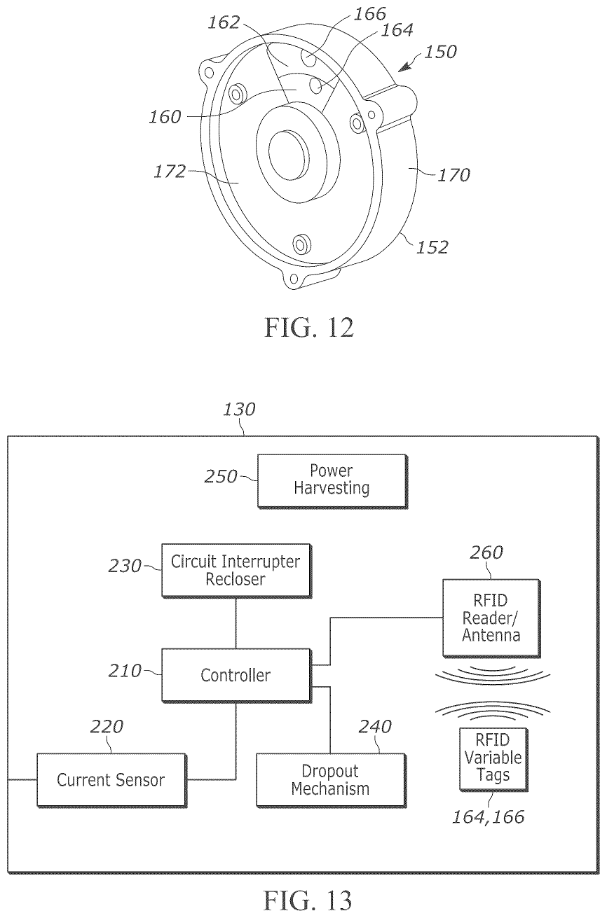

As best shown in FIG. 12, the dial housing 152 can include a front panel 170 and a rear panel 172. The rear panel 172 can include a rear window that provides communication with the selected tags 164, 166, while the rear panel 172 covers the remaining tags. The material of the rear panel 172 can be selected to block the RFID signal from the unexposed tags 164, 166. For example, different materials such as aluminum or stainless steel can be used. Other materials, such as conductive fabrics, or coatings, such as an RFID blocking paint, can be used to allow for transmission to and from only the selected tags 164, 166.

In certain forms, the tags 164, 166 may include one or more markings (e.g., writing, symbols, etc.) that correspond to a selection. A user interfacing with the selector dial 150 may be able to see the markings in order to determine the position of the tags 164, 166. In some configurations, the RFID tags 164, 166 can be replaced with other types of indicator/reader combinations. For example, an optical reader can be used with a bar code (e.g., linear barcode, matrix bar code, etc.) to provide a signal to the controller.

FIG. 13 shows an exemplary schematic of the recloser 130 that utilizes a RFID reader/antenna 260 in communication with the controller 210 and the tags 164, 166. The RFID system can operate at different frequency levels depending on the environment and application. The reader/antenna 260 can be one or more devices or components as would be understood by one of ordinary skill in the art, and is shown as a single block for simplicity. The reader/antenna 260 is configured to receive information from the tags 164, 166 and pass the information or instructions to the controller 210.

In certain configurations, the RFID tags 164, 166 can be passive tags that are activated by the reader/antenna 260. The reader/antenna 260 can emit a radio frequency signal which creates an electromagnetic field in the proximity of the tags 164, 166. This activates the tags 164, 166 by inducing an electrical current which briefly powers the tags IC. Once powered, the tags IC modulates the RF signal with its unique identification number and other stored data. This modulation alters the characteristics of the RF signal, encoding the tag's information into it. The modulated signal is then reflected back from the tag's antenna toward the reader 260.

The reader/antenna 260 receives the modulated RF signal from the passive tags 164, 166 through its antenna. In some configurations, the reader/antenna 260 can include electronics that interpret the changes in the RF signal, extracting the encoded data from the tags 164, 166 and transmitting it to the controller 210 which then operates according to the selected fuse curve. In some configurations, the controller is programmed to interpret the information transmitted by the tags 164, 166 and associate the information with the proper fuse curve. The controller 210 can be configured to retrieve the requested operating parameters from a local memory or the operating parameter information can be transferred via the RF response signal emitted by the tags 164, 166.

In a passive tag system, the reader/antenna 260 can be configured to be continuously pinging the tags 164, 166 for information or can be set to operate at certain intervals. In other embodiments, the RFID system can be configured where the tags 164, 166 are active and the reader/antenna 260 is passive or both components are active. The tags 164, 166 can also be activated when a selection is made or changed so that the reader/antenna 260 and controller 210 update only as needed.

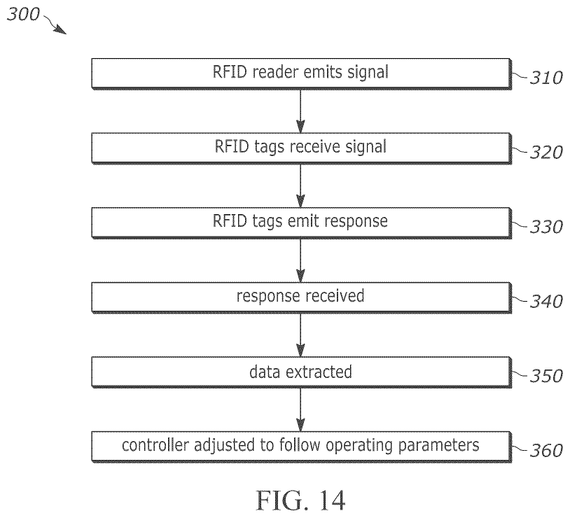

FIG. 14 shows an exemplary flow chart 300 for the controller 210 to select a fuse curve. In a first step, an RFID reader emits an RF signal 310. The reader can be controlled by an external controller or through internal programming. One or more RFID tags receive the RF signal 320. The RFID tag(s) emits a response 330 which includes information (e.g., encoded data) programmed into the RFID tag relating to a selected fuse curve and/or fuse amp setting. The response is received by the reader 340 and the data is extracted 350. The data can be extracted by the reader or by the controller. The controller can then access and follow the selected operating parameters 360. For example, the controller will follow the selected fuse curve and/or amp rating selected by a user. The controller can receive the operating parameter information or associated data from a local memory, or the information can be provided by the RFID tag in the emitted response.

In certain forms, the controller may communicate with an external device (e.g., a computer) with a user interface. The controller may send the selected fuse curve and/or amp rating to the external device to allow a remote user to monitor the selection.

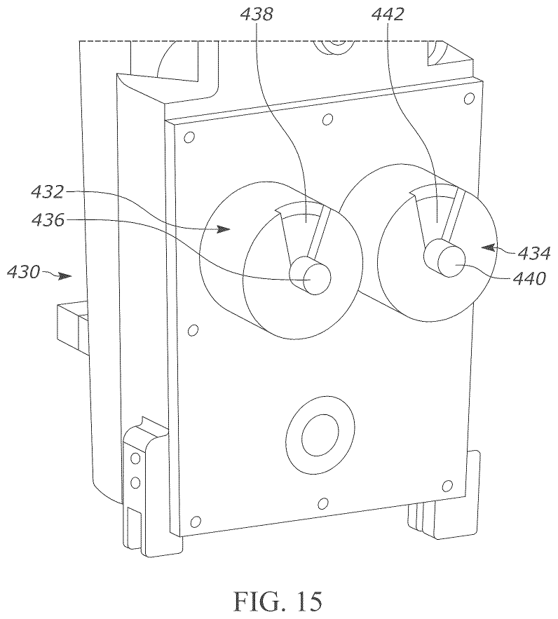

FIG. 15 shows another exemplary embodiment of a recloser 430 utilizing a first dial 432 and a second dial 434. The first dial 432 includes a first knob 436 connected to a first ring 438. The second dial 434 includes a second knob 440 connected to a second ring 442. The first dial 432 can be used to set one of the curve type or the amp rating for the fuse curve, and the second dial 434 can be used to set the other of the curve type and the amp rating for the fuse curve. The first and second rings 438, 442 can include visual indicators that assist a user in selecting a desired curve. The selected curve type and amp rating can then be transmitted to a controller 210. The illustrated first and second dials 432, 434 are shown as being substantially the same size and proximate to one another. However, other examples may include different sized dials 432, 434 and/or dials 432, 434 spaced apart from one another.

In certain configurations a wireless signal, such as an RFID system described herein can be used to signal between the first and second dials 432, 434 and the controller 210. In other embodiments, other types of wireless signals may be used (e.g., magnetic, Bluetooth, Wi-Fi, cellular networks, etc.).

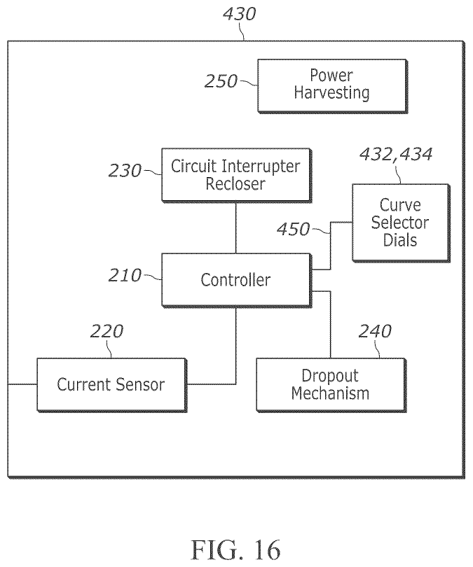

In still other embodiments, as illustrated in FIG. 16, a non-wireless connection 450 (either mechanical, electrical, or combination thereof) can be used. The controller 210 can be configured to adjust the operating parameters to match the selected fuse curve based on the position of the dials selected by the user.

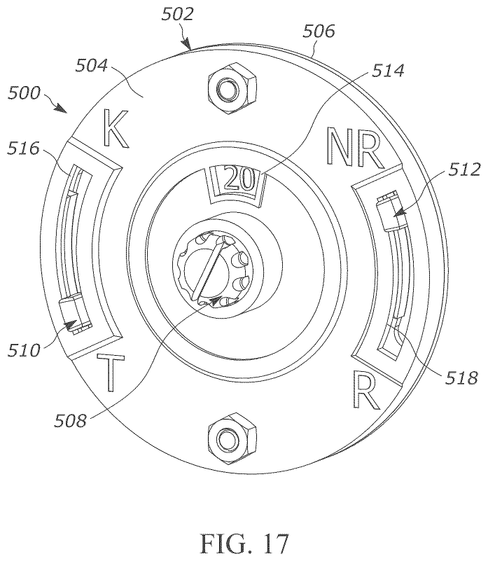

FIG. 17 shows another configuration of a variable current selector 5oo. The variable current selector 500 includes a housing 502 having a front housing portion 504 and a rear housing portion 506. The front housing portion 504 and rear housing portion 506 can be separate members that are connected by one or more fasteners.

The variable current selector 500 includes an inner selector 508, a first outer selector 510, and a second outer selector 512. The inner selector 508, first outer selector 510, and second outer selector 512 are rotatable relative to the housing 502 to allow a user to adjust the settings of a fuse device, for example a recloser. By adjusting the different selectors, a user can signal the internal controller 210 to adjust the device settings, for example the fuse curve settings of the recloser.

In the illustrated configuration, the inner selector 508 allows a user to rotate a dial to select a plurality of amperage settings. For example, amperage settings of 2, 3, 5, 6, 8, 10, 12, 15, or 20 amps. The inner selector 508 can include a plurality of visual indicators that indicate which amp rating is selected. The front housing portion 504 can include a viewing window 514 that allows a user to see the visual indicators of the inner selector 508.

The first outer selector 510 can be shifted between two or more positions to allow a user to select a desired fuse curve. The illustrated configuration shows two types of fuse curves that can be selected (K and T types). The front housing portion 504 can include visual indicators to inform a user which fuse curve is being selected. Other configurations can allow for more than two types of selections. The front housing portion 504 can also include a first front slot 516 that allows the first outer selector 510 to be moved between positions.

The second outer selector 512 can allow a user to change operating conditions of the fuse device. The illustrated configurations shows a recloser mode (R) and non-recloser mode (NR). The front housing portion 504 can include visual indicators to inform a user which mode is being selected. Other configurations can allow for more than two types of selections. The front housing portion 504 can also include a second front slot 518 that allows the second outer selector 512 to be moved between positions.

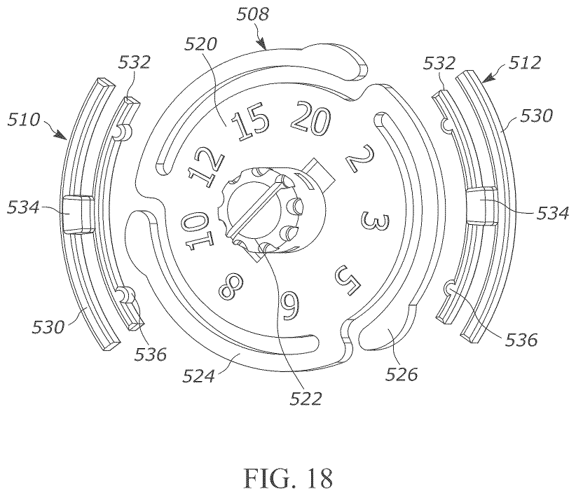

FIG. 18 shows an exemplary configuration of the inner selector 508 having a body 520, a knob 522 extending from the body 520, and one or more arms 524 extending from the body 520. The body has a substantially circular configuration. A plurality of visual indicators (e.g., amp rating values) are provided on the body 520 to allow a user to determine the selected amperage.

The knob 522 extends from a central region of the body 520. The knob 522 can extend through a central boss in the front housing portion 504 so that a user can manipulate the body 520. In certain implementations, the body 520 is rotatable by a user via the knob 522 to select different values. The knob 522 can have a slot to receive a tool, such as a flat-head screw driver to allow for hand or tool manipulation of the knob 522.

One or more arms 524 extend from the outer edge of the body 520. In the illustrated configuration, three arms 524 extend in a circumferential direction, although fewer or more arms 524 can be used. The arms 524 can have a cantilever configuration with a living hinge connecting the arms 524 to the body 520. In certain configurations, a tab 526 can extend from the end of each arm 524.

FIG. 18 also shows the first outer selector 510 and the second outer selector 512. Each of the first outer selector 510 and the second outer selector 512 can include an outer arm 530, an inner arm 532, and a protrusion 534 bridging the outer arm 530 and the inner arm 532. The outer arms 530 and inner arms 532 have a curved configuration, although other configurations can be used. One or more tabs 536 can extend from the inner arms 532 away from the outer arms 530 and toward the center of the selector.

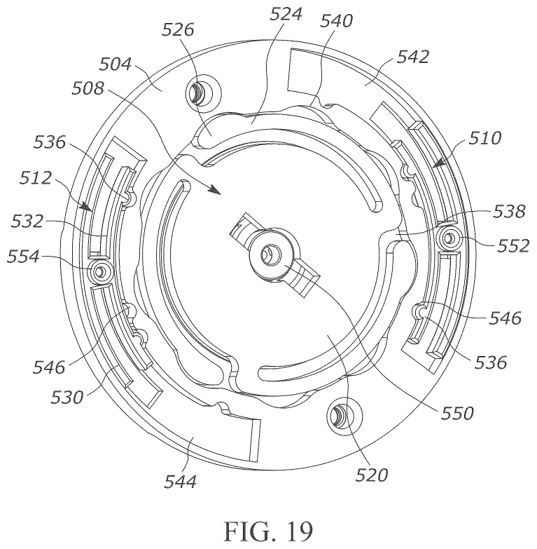

FIG. 19 shows the inner selector 508, first outer selector 510, and second outer selector 512 positioned in the front housing portion 504. The front housing portion 504 can include an inner recessed portion 538 receiving the inner selector 508. The inner recessed portion 538 can include a plurality of inner grooves 540 configured to receive the tabs 526 of the arms of the inner selector. The grooves 540 can be arrayed around the outer edge of the inner recessed portion 538. The interface of the grooves 540 and the tabs 526 can provide tactile feedback to a user and a snap-fit connection for the inner selector 508 at set radial positions that correspond to the set selector values.

The front housing portion 504 also includes a first outer recessed portion 542 and a second outer recessed portion 544. The first outer recessed portion 542 receives the first outer selector 510 and the second outer recessed portion 544 receives the second outer selector 512. The first outer recessed portion 542 and second outer recessed portion 544 can include one or more outer grooves 546. The outer grooves 546 are configured to receive the tabs 536 of the inner arms 532 of the outer selectors 510, 512. The grooves 546 are positioned to provide tactile feedback and a snap-fit connection between the set positions for the outer selectors 510, 512.

In certain configurations, the inner selector 508, the first outer selector 510, and the second outer selector 512 are configured to signal the controller 210 using one or more magnets. For example, the inner selector 508 can include an inner magnet 550. The inner magnet 550 can have a cylindrical configuration and be rotatably fixed to the inner selector 508. The first outer selector 510 can include a first outer magnet 552 positioned, for example, in the protrusion 534 of the first outer selector 510. The second outer selector 512 can include a second outer magnet 554 positioned, for example, in the protrusion 534 of the second outer selector 512.

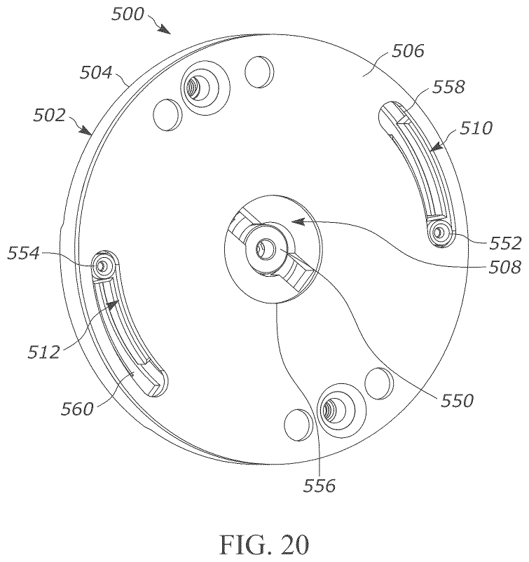

As shown in FIG. 20, the rear housing portion 506 can include a series of openings to provide communication for the magnets with one or more sensors. The rear housing portion 506 can include a inner rear opening 556 exposing the inner magnet 550. A first outer rear opening 558 can expose the first outer magnet 552. A second outer rear opening 560 can expose the second outer magnet 554.

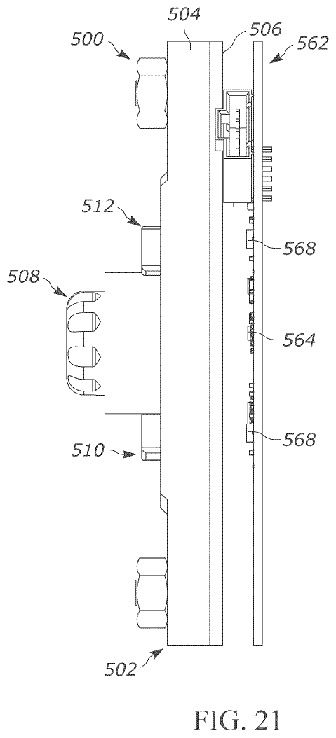

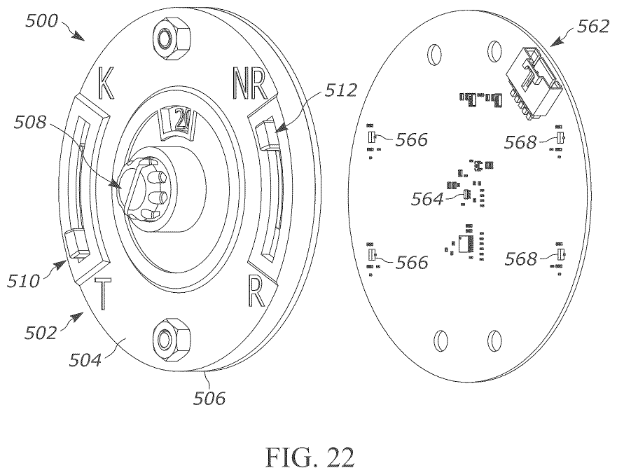

In certain configurations, the inner magnet 550, the first outer magnet 552, and the second outer magnet 554 can signal the controller 210 via one or more sensors. FIGS. 21 and 22 show an exemplary configuration of a printed circuit board 562 including an inner sensor 564, a first pair of outer sensors 566, and a second pair of outer sensors 568. In certain implementations, the printed circuit board 562 is a peripheral board connected to the main controller 210 and supported inside of the housing of the recloser. In other configurations, the printed circuit board can be incorporated into the main controller 210. The controller 210 can adjust the operation settings of the fuse device based on the selected user settings.

In certain implementations, Hall Effect sensors can be used that create signals based on movement of the magnets. In certain configurations, the inner magnet 550 can be a ring magnet with a north and south pole. The inner sensor 564 can be positioned to detect rotation of the inner magnet 550 by measuring the flux created by the angle of the N/S boundary relative to the inner sensor 564. As shown in the illustrated configuration, the inner sensor 564 can be positioned axially with the inner magnet 550. In other configurations, one or more inner sensors 564 can be positioned out-of-plane with the inner magnet 550 to measure the position.

In other configurations, the inner magnet 550 can be a ring magnet with a plurality of N/S poles. The inner sensor 564 can be positioned to detect rotation of the inner magnet 550. When the inner magnet 550 rotates, the transitions between the N and S regions will trigger a signal in the inner sensor 564, which can be used to track the position of the inner selector 508.

In certain configurations, the first pair of outer sensors 566 and the second pair of outer sensors 568 determine the position of the outer selectors 510, 512 by registering which of the magnets 566, 568 (upper or lower) of the pair are activated by the respective outer magnets 552, 554. In other configurations, a single sensor can be used for each selector 510, 512 which can register passage of the respective magnet 552, 554 to determine the position of the selector 510, 512.

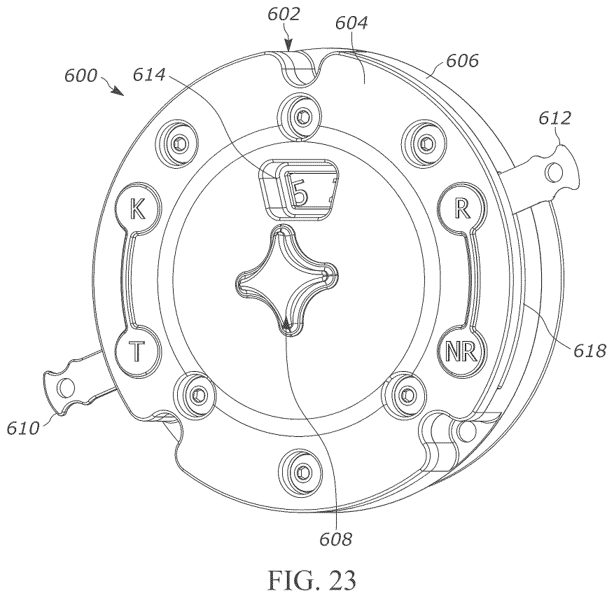

FIG. 23 shows another configuration of a variable current selector 600. The variable current selector 600 includes a housing 602 having a front housing portion 604 and a rear housing portion 606. The front housing portion 604 and rear housing portion 606 can be separate members that are connected by one or more fasteners.

The variable current selector 600 includes an inner selector 608, a first outer selector 610, and a second outer selector 612. The inner selector 608, first outer selector 610, and second outer selector 612 are rotatable relative to the housing 602 to allow a user to adjust the settings of a fuse device, for example a recloser. By adjusting the different selectors, a user can signal the internal controller 210 to adjust the device settings, for example the fuse curve settings of the recloser.

In the illustrated configuration, the inner selector 608 allows a user to rotate a dial to select a plurality of amperage settings. For example, amperage settings of 2, 3, 5, 6, 8, 10, 12, 15, or 20 amps. The inner selector 608 can include a plurality of visual indicators that indicate which amp rating is selected. The front housing portion 604 can include a viewing window 614 that allows a user to see the visual indicators of the inner selector 608.

The first outer selector 610 can be shifted between two or more positions to allow a user to select a desired fuse curve. The illustrated configuration shows two types of fuse curves that can be selected (K and T types). The front housing portion 604 can include visual indicators to inform a user which fuse curve is being selected. Other configurations can allow for more than two types of selections. The rear housing portion 606 can also include a first front slot that allows the first outer selector 510 to be moved between positions.

The second outer selector 612 can allow a user to change operating conditions of the fuse device. The illustrated configurations shows a recloser mode (R) and non-recloser mode (NR). The front housing portion 604 can include visual indicators to inform a user which mode is being selected. Other configurations can allow for more than two types of selections. The rear housing portion 604 can also include a second front slot 618 that allows the second outer selector 612 to be moved between positions.

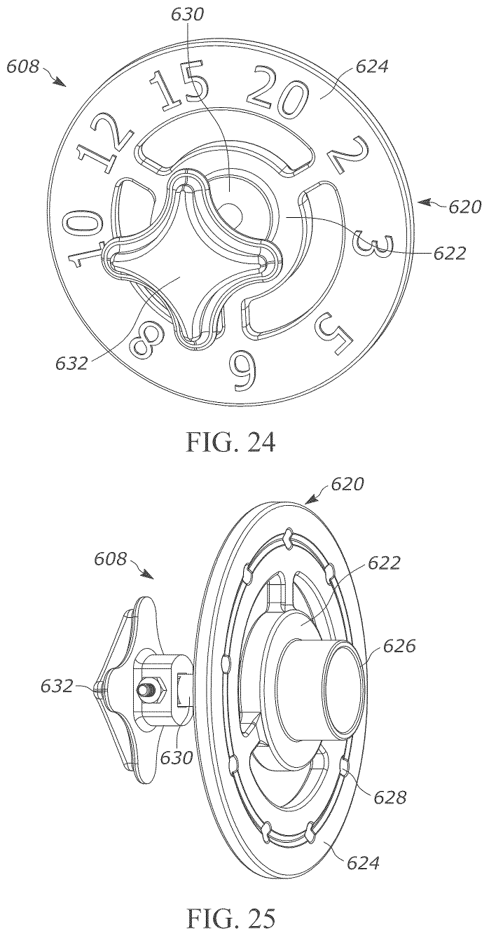

FIGS. 24 and 25 show an exemplary configuration of the inner selector 608 having a body 620 with an inner ring 622 and an outer ring 624. A hub 626 extends from the rear of the inner ring 622. A plurality of depressions 628 can extend into the rear of the outer ring 624. A shaft 630 extends from the inner ring 622. A knob 632 extends from the shaft 630. A plurality of visual indicators (e.g., amp rating values) are provided on the body 620 to allow a user to determine the selected amperage.

The knob 632 can be connected to the shaft 630 by a fastener, or through another connection such as an interference fit. The knob 632 can extend through a central boss in the front housing portion 604 so that a user can manipulate the body 620. In certain implementations, the body 620 is rotatable by a user via the knob 632 to select different values.

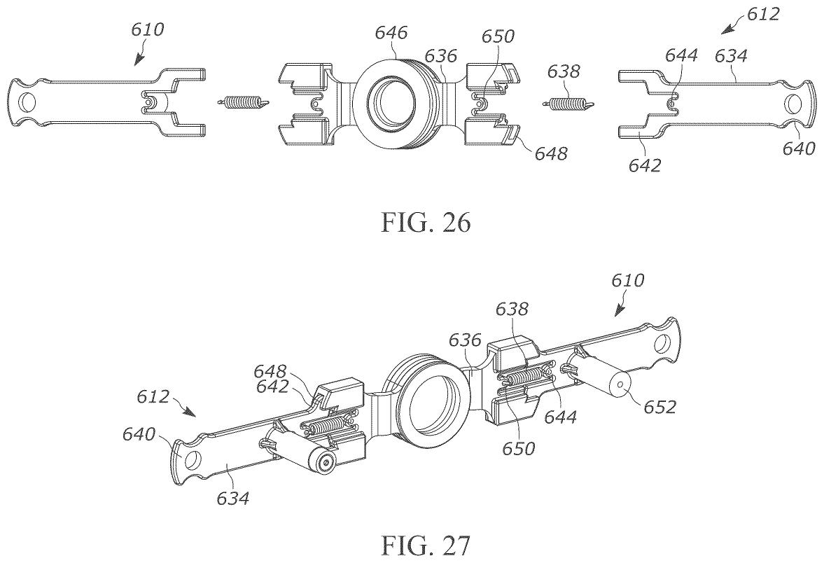

FIGS. 26 and 27 show an exemplary configuration of the first outer selector 610 and the second outer selector 612. Each of the first outer selector 610 and the second outer selector 612 can include an outer arm 634, an inner arm 636, and a biasing mechanism 638, for example a tension spring. The outer arm 634 includes an outer user interface end 640 and an inner end having a set of outer tines 642. An outer tab 644 connects the biasing spring 638. The inner arm 636 includes an inner ring 646 and outer slots 648 that receive the tines 642 of the outer arm 634. An inner tab 650 connects the biasing spring 638. A cylindrical projection 652 can extend from the rear of the outer arm 634. The outer arms 634 are moveable relative to the inner arms 636, with the tines 642 slidably engaging the grooves 648. When outer arm 634 is extended it is biased toward the inner arm 636 by the biasing mechanism 638. This biasing action can help provide a tactile feedback to a user when switching operating conditions as the outer arms 634 can pull away from the inner arms 636 when moving between the upper and lower positions.

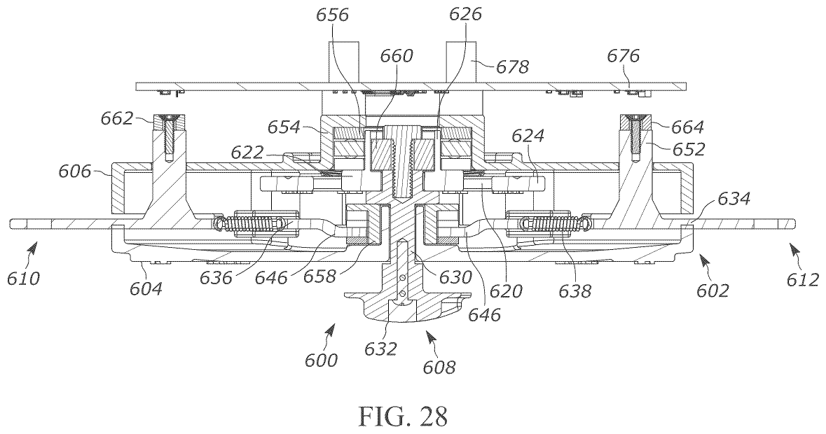

FIG. 28 shows the inner selector 608, first outer selector 610, and second outer selector 612 positioned in the housing 602. The hub 626 of the inner selector 508 extends into a chamber 654 of the rear housing portion 606. A rear bearing assembly 656 rotatably supports the hub 626 and body 620 of the inner selector 608 in the rear housing portion 606. The inner ring members 646 of the outer selectors 610, 612 are rotatably connected to a collar 658 positioned around the shaft 630. The respective ring members 646 are offset from one another and coaxially connected to the collar 658 so that they are independently moveable.

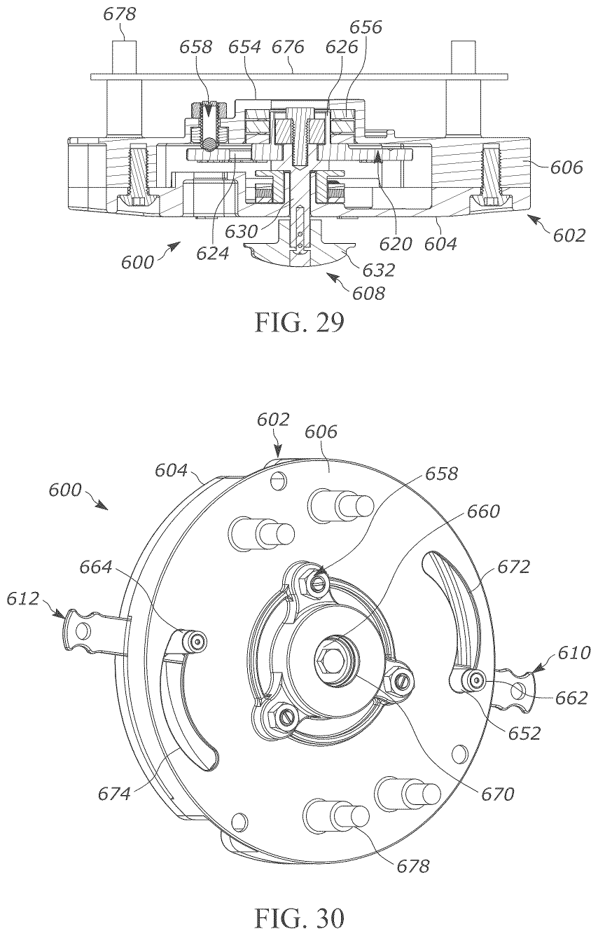

In certain configurations, the selector 600 can include one or more feedback mechanisms to assist a user in proper positioning of the inner selector 608. As best shown in FIG. 29, one or more ball plungers 658 can be configured to engage the depressions 628 in the rear of the outer ring 624. The ball plungers 658 can be threadably connected to the rear housing portion 606. A moveable ball is positioned in a shaft and biased outwardly by a spring. Then the inner selector 608 is rotated by the knob 632, the ball will engage and disengage the plurality of depressions 628 providing tactile feedback to a user for the correct positions of the inner selector 608. In certain configurations, three ball plungers 658 can be equally positioned, for example at 120 degree intervals for a circular selector.

In certain configurations, the inner selector 608, the first outer selector 610, and the second outer selector 612 are configured to signal the controller 210 using one or more magnets. For example, the inner selector 608 can include an inner magnet 660. The inner magnet 660 can have a cylindrical configuration and be rotatably fixed to the inner selector 608. The first outer selector 610 can include a first outer magnet 662 extending from, for example, the protrusion 652 of the first outer selector 610. The second outer selector 612 can include a second outer magnet 664 extending from, for example, the protrusion 652 of the second outer selector 612.

As shown in FIG. 30, the rear housing portion 606 can include a series of openings to provide communication for the magnets with one or more sensors. The rear housing portion 606 can include an inner rear opening 670 exposing the inner magnet 660. The rear protrusions 652 of the first outer selector 610 can extend through a first slot 672 in the rear housing portion 606 and the rear protrusion 652 of the second outer selector 612 can extend through a second slot 674 in the rear housing portion 606. The first and second slots 672, 674 can have an elliptical configuration so that movement between the upper position and the lower position will pull the outer arm 634 away from the inner arm 636. This will lengthen the biasing mechanism 638, which will pull the outer arm 634 back in through the mid-point of the curve. This will provide a snap feedback to the user as the biasing mechanism pulls the outer arm 634 inwardly.

In certain configurations, the inner magnet 660, the first outer magnet 662, and the second outer magnet 664 can signal the controller 210 via one or more sensors. FIGS. 28 and 29 show an exemplary configuration of a printed circuit board 676 connected to the housing 602 by one or more posts 678. The printed circuit board 676 can have one or more hall effect sensors positioned to receive signals from the magnets 660, 662, 664 as shown and described with respect to FIGS. 21 and 22.

While an exemplary embodiment of the recloser is described in connection with a fuse cutout insulator and related components for a power distribution system, it will be readily apparent to one of ordinary skill in the art armed with the present specification that the components described herein can be applied to a multiplicity of fields and uses. In particular, the recloser can be used in connection with a power fuse or a sectionalizer. Likewise, the exemplary embodiments may be advantageous when coupling with a conductive blade to form an airbreak switch or used to hold other circuit make/break and sensing devices. The engagement interfaces can also be incorporated into other devices such as a fuse tube or other power distribution fuse components. Finally, one of ordinary skill in the art armed with the present specification will also understand that the present system may be easily modified to include different configurations, mechanisms, methods, and kits, which achieve some or all of the purposes of the present disclosure.

The foregoing detailed description of the certain exemplary embodiments has been provided for the purpose of explaining the general principles and practical application, thereby enabling others skilled in the art to understand the disclosure for various embodiments and with various modifications as are suited to the particular use contemplated. This description is not necessarily intended to be exhaustive or to limit the disclosure to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings.

What is claimed:

1. A recloser for a distribution system comprising:
a current sensor configured to measure an operating current of a distribution system;
a controller connected to the current sensor, the controller having at least one processor;
a circuit interrupter connected to the controller and configured to open a circuit to interrupt power in at least a portion of the distribution system; and
a selector in communication with the controller, the selector operable by a user to select one of a plurality of fuse curves,
wherein the controller is configured to trigger the circuit interrupter to open the circuit in response to a detected fault current and wherein the fault current is determined based on a selected fuse curve of one of the plurality of fuse curves.

2. The recloser of claim 1, wherein the selector is in radio frequency communication with the controller.

3. The recloser of claim 1, wherein the selector includes a first knob and a second knob.

4. The recloser of claim 3, wherein the first knob controls the rotation of a first ring and the second knob controls the rotation of a second ring.

5. The recloser of claim 1, wherein the selector is a user interface connected to the controller via a non-wireless connection.

6. The recloser of claim 1, wherein the selector allows a user to select a fuse curve type.

7. The recloser of claim 1, wherein the selector allows a user to select a fuse curve amperage rating.

8. The recloser of claim 1, wherein the selector allows a user to select an operating parameter.

9. The recloser of claim 1, wherein the selector includes an inner selector, a first outer selector, and a second outer selector.

10. The recloser of claim 9, wherein the inner selector allows a user to select an amperage rating, the first outer selector allows a user to select a fuse curve type, and the second outer selector allows a user to select an operating parameter.

11. The recloser of claim 1, wherein the selector is in magnetic communication with the controller.

12. The recloser of claim 1, wherein the selector includes a first magnet and a sensor connected to the controller.

13. The recloser of claim 12, wherein the sensor is a hall-effect sensor connected to a printed circuit board.

14. A distribution system fuse device comprising:
an insulator body having a weathershed;
a support bracket extending from the insulator body;
a hood connected to the insulator body, the hood having a hood contact;
a hinge member extending from the insulator body; and
a recloser pivotally connected to the insulator body by engagement of a pivot with the hinge member, the recloser having,
a current sensor configured to measure an operating current of a distribution system,
a controller connected to the current sensor, the controller having at least one processor,
a circuit interrupter connected to the controller and configured to open a circuit to interrupt power in at least a portion of the distribution system, and
a selector in communication with the controller, the selector operable by a user to select one of a plurality of fuse curve,
wherein the controller is configured to trigger the circuit interrupter to open the circuit in response to a detected fault current and wherein the fault current is determined based on a selected fuse curve of one of the plurality of fuse curves.

15. The distribution system fuse device of claim 14, wherein the selector is in radio frequency communication with the controller.

16. The distribution system fuse device of claim 14, wherein the selector includes a plurality of magnets and a plurality of hall-effect sensors in communication with the magnets.

17. A method of setting the operating parameters of a controller for a distribution system fuse device comprising:
adjusting the position of a selector;
sensing the change in position of the selector;
emitting a signal to a controller based on the change in position of the selector;
receiving, by one or more processors of the controller, the signal and extracting fuse curve data based on the signal; and
adjusting the operating parameters of a controller based on the fuse curve data.

18. The method of claim 17, wherein adjusting the selector includes moving the position of a magnet and sensing the change in position of the selector includes sensing the change in position of the magnet.

19. The method of claim 17, wherein the fuse curve data includes at least one of a curve type or an amp rating.

20. The method of claim 17, wherein the data is extracted from a local memory.
